(19) United States
(12) Patent Application Publication
(10) Pub. No.: US 2021/0089635 A1
(43) Pub. Date: Mar. 25, 2021

(54) BIOMETRIC IDENTITY VERIFICATION AND PROTECTION SOFTWARE SOLUTION

(71) Applicant: MeetSID LLC, Netwon, MA (US)

(72) Inventor: Anthony Weeresinghe, Newton, MA (US)

(21) Appl. No.: 16/582,709

(22) Filed: Sep. 25, 2019

(51) Int. Cl. G06F 21/32; G06K 9/00

(52) U.S. Cl. CPC G06F 21/32; G06K 9/00483

(57) ABSTRACT

In various embodiments, a biometric identity verification and protection software solution is described that operates as a central source of real-time KYC verification and anti-fraud prevention. A cloud-based secured digital wallet is established. When a user is on boarded, baseline biometric indicia (e.g., indicia of their face, voice, etc.) is captured, copies of identification documents are authenticated, and at least some of the baseline biometric indicia verified against reference biometric indicia in the authenticated identification documents. Upon verification, the biometric indicia and copies of identification documents are stored in the secured digital wallet. Each time the user desires to login or otherwise utilize the resources/services of an institution, current biometric indicia are captured, and at least some is compared against the baseline biometric indicia in the secured digital wallet. In response to a match, the software solution provides an indication to the institution that the user is indeed who they claim to be.

### BACKGROUND

### Technical Field

The present disclosure relates to generally to electronic fraud prevention and more specifically to biometric identity verification and protection.

### Background Information

Identity fraud has become one of the most serious and prevalent forms of cybercrime globally. In 2017, there were at least 16.7 million identity fraud victims in the United States alone, leading to an estimated 16.8 billion dollars in losses. At least 40% of consumers across the globe have been targets of identity fraud at least once. In 2018, approximately 8 million personal records were stolen per day on average. People of all ages and socio-economic backgrounds are victims of identify fraud. In recent years, approximately 1.3 million children have had their identities stolen each year.

Financial, e-commerce, customs and border protection, law enforcement, social-media and other institutions (collectively referred to herein simply as “institutions”) increasingly require effective know-your-customer (“KYC”) and fraud prevention solutions to combat the growing problem of identity fraud. However, existing software solutions have a number of shortcomings.

One shortcoming is that institutions currently each take responsibility for verifying a user's identity; there is no centralized verifier of identity. Each time a user opens a new account with an institution, the user is generally required to provide, or the institution pulls automatically from third-party vendors, confidential records related to credit history, employment history, social media and on-line history, and the like. This process is repeated every time the user opens an account with a new institution. The repeated transfer of this data increases the likelihood of its theft and future fraud. Further, the user often has little knowledge or control over exactly what information the institution has access to. The user is largely powerless in controlling information about their identity.

Another shortcoming is that institutions currently rely heavily on a one-time assessment of user identity, typically when the user opens an account with the institution. At such time, the institution typically assigns proxies for identity to the user, and thereafter only verifying those proxies. For example, the institution may have the user set a password, answer security questions, enter mobile phone numbers and email addresses, etc. Thereafter, to access the resources/services of the institution, these proxies for user identity are verified. The user's actual identity is not verified. This may lead to a vulnerability where, despite the number of proxies, that are verified there is only truly one layer of identity protection. For example, in a typical “two-factor” authentication, two proxies, such as a password, and a code sent by text or email, are verified. However, if a hacker is able to dupe the institution during the initial enrolment, they can set their own password and cell number/email address. Therefore, there is actually only one layer of protection (e.g., a layer provided by the initial verification).

In addition to identity fraud prevention, institutions are also faced with challenges of anti-money laundering compliance. Currently, anti-money laundering compliance requires institutions to maintain detailed records of financial transactions. Regulators use this data to investigate suspicious users, typically focusing on tracing funds after a crime has been committed. Currently, there are limited options for enforcing real-time anti-money laundering compliance and protecting unsuspecting third parties from money launderers.

Still further, institutions are also faced with challenges in identifying unknown persons. For example, in relation to border crossing, human trafficking, child trafficking and other types of customs, border control, and law enforcement activities, there may be a need to search for and verify the identity of an unknown person. While some special purpose systems and databases exist, they are often limited by geo-political borders, difficult to use, and sometime inaccurate.

Accordingly, there is a need for an improved identity verification and protection solution that may address some or all of the above discussed shortcomings.

### SUMMARY

In various embodiments, a biometric identity verification and protection software solution is described that operates as a central source of real-time KYC verification and anti-fraud prevention. A cloud-based secured digital wallet is established and a unique digital identity identifier (e.g., a KYC Safe ID) that is associated therewith. When a user is on boarded, baseline biometric indicia (e.g., indicia of their face, voice, etc.) is captured, copies of identification documents are authenticated, and at least some of the baseline biometric indicia verified against reference biometric indicia in the authenticated identification documents. Upon verification, the biometric indicia and copies of identification documents are stored in the secured digital wallet. Copies of documents may be associated with their own asset specific identifiers (e.g., Asset Safe IDs). Each time the user desires to login or otherwise utilize the resources/services of an institution, current biometric indicia are captured, and at least some is compared against the baseline biometric indicia in the secured digital wallet. In response to a match, the software solution provides an indication to the institution that the user is indeed who they claim to be. If the institution requires information or documents of the user, the institution may be provided unique digital identity token (e.g., a KYC token or Asset token) using which they may access information or documents stored in the secured digital wallet.

The biometric identity verification and protection software solution may allow a user to be the centralized authority for their own identity, controlling the contents of their own secured digital wallet. Further, by employing a “prevention” model, where identity verification occurs each time the user utilizes the resources/services of an institution, the shortcomings of relying upon proxies for identity and one-time assessments of identity are avoided, allowing acts of fraud to be detected as they occur, rather than after the fact.

The biometric identity verification and protection software solution may be adapted to provide a variety of other functionality. For example, it may provide real-time anti-money laundering compliance. Likewise, the biometric identity verification and protection software solution may also be adapted to provide unknown person identification services.

It should be understood that a variety of additional features and alternative embodiments may be implemented other than those discussed in this Summary. This Summary is intended simply as a brief introduction to the reader, and does not indicate or imply that the examples mentioned herein cover all aspects of the disclosure, or are necessary or essential aspects of the disclosure.

### BRIEF DESCRIPTION OF THE DRAWINGS

The description below refers to the accompanying drawings of example embodiments, of which:

FIG. 1 is a block diagram of an example architecture for a biometric identity verification and protection software solution;

FIG. 2 is a flow diagram for an example sequence of steps for onboarding a user using the example architecture of FIG. 1;

FIG. 3 is a flow diagram for an example sequence of steps for authenticating a non-machine readable identification document using physical verification;

FIG. 4 is a flow diagram of an example sequence of steps for account login using the example architecture of FIG. 1;

FIG. 5 is a flow diagram of an example sequence of steps for transaction verification using the example architecture of FIG. 1; and

FIG. 6 is a flow diagram of an example sequence of steps for unknown person identification.

### DETAILED DESCRIPTION OF EXAMPLE EMBODIMENTS

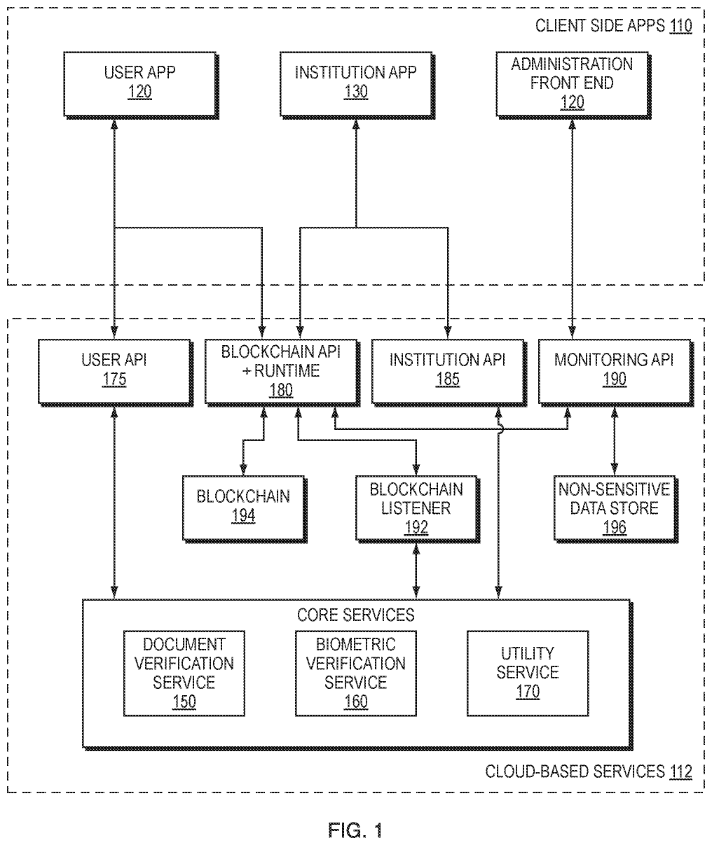

FIG. 1 is a block diagram of an example architecture for a biometric identity verification and protection software solution. The architecture may be divided into client-side applications (apps) 110 and cloud-based services 112. The client-side apps 110 may including a user app (e.g., an IOS® or Android® app) 120 executing on a user electronic device (e.g., a mobile device, such as a smartphone), an institution app 130 executing on an institution electronic device, and an administration front end 140 webpage executing within a web-browser.

The user app 120 may be the primary user interface (UI) for a user, including subprocesses that support a number of functions. These functions may include user onboarding and login, capturing biometric information (e.g., images of the user's face, recordings of the user's voice, etc.) using sensors of the user electronic device (e.g., a camera, microphone, etc.), distilling the biometric information into more concise biometric indicia (e.g., via machine learning and image processing techniques, such as facial landmark and contour detection), using sensors of the user electronic device (e.g., a camera) and processing algorithms (e.g., edge detection, perspective transforms, etc.) to capture copies of identification documents (e.g., a driver's license, passport, national identification card (NIC), birth certificate, etc.), uploading biometric indicia and copies of identification documents upon demand, action verification, as well as a wide variety of other functions.

The institution app 130 may be the primary UI for institutions to support physical verification for non-machine-readable identification documents (i.e. documents that lack encoded information and/or a corresponding digital database to support electronic authentication) and other functions. These functions may include capturing machine-readable optical labels (e.g., QR codes), using sensors of the institution electronic device (e.g., a camera) and processing algorithms (e.g., edge detection, perspective transform, etc.) to capture copies of the non-machine-readable identification documents, using sensors of the institution electronic device (e.g., a camera) to capture biometric information (e.g., an image of the user's face), distilling the biometric information into more concise biometric indicia (e.g., via machine learning and image processing techniques such as facial landmark and contour detection), uploading copies of the non-machine-readable identification documents and biometric indicia, as well as a wide variety of other functions.

The administration front end 140 may be utilized by institutions, system operators or other parties to view and manage operation of the biometric identity verification and protection software solution. The functions of the administration front end 140 may be role based, with a single-page web application created for each roll providing allowed actions for that role.

The cloud-based services 112 may include core services, such as a biometric service 150, a document verification service 160, and a utility service 170 with a, a non-sensitive data store 196. The cloud-based services 112 may also include web application program interfaces (APIs) and other processes, such as an institution API 185, a monitoring API 190, a blockchain listener 192, a blockchain environment including a blockchain runtime and blockchain API (collectively 180), and a secure blockchain data storage 194.

The biometric service 150 is responsible for comparing and determining matches between baseline biometric indicia and reference biometric indicia as part of onboarding a user, and comparing current biometric indicia to baseline biometric indicia as part of verifying an action (e.g., a transaction) as performed by the user. The biometric service 150 may include a face biometric service that compares facial biometric indicia (e.g., universally encoded facial features) using deep leaning techniques, and a voice biometric service that compares voice biometric indicia (e.g., audio features extracted from voice) using probabilistic and machine learning algorithms.

The document verification service 160 is responsible for extracting information from and authenticating identification documents (e.g., in terms of proof of ownership, data integrity analytics and visual document authenticity analytics). The document verification service 160 may include a text reading service for extracting textual information, an extraction and processing service for extracting reference biometric information (e.g., an image of the user's face) and distilling it to reference biometric indicia, and a digital authentication service for comparing information with a reference database.

The utility service 170 is responsible for administrative functions including communications, statistics calculation, and reporting. The utility service 170 may maintain and utilize information from the non-sensitive data store 196, including statistics, mappings and other data.

The web APIs may be REpresentational State Transfer (REST)ful APIs. The user API 175 may support operations of the user app 120, including transfer of information for login, onboarding, action verification, unique digital identifier (e.g., KYC Safe ID and Asset Safe ID) mapping and other functions. The institution API 185 may support operations of the institution app 130, including transfer of information for action verification, request handing, and physical verification. The monitoring API 190 may support operations of utility services 170 including transfer of information for supporting front end interactions.

The blockchain API may be a RESTful API that provides access to the secured blockchain 194 and the results of core services via the blockchain listener 192 to client-side applications 110 and web APIs. The blockchain runtime may generate a unique digital identity identifier (e.g., a KYC Safe ID) for each user and asset specific identifiers (Asset Safe IDs) for each identification document. The blockchain may store the contents of users' secured digital wallets, including identification documents (e.g., drivers license, passport, NIC, birth certificate, etc.), baseline biometric indicia (e.g., indicia of their face, voice, etc.), user biographical information (e.g., name, address, email, mobile number, etc.) and other information in a list of records (“blocks”) that are linked cryptographically.

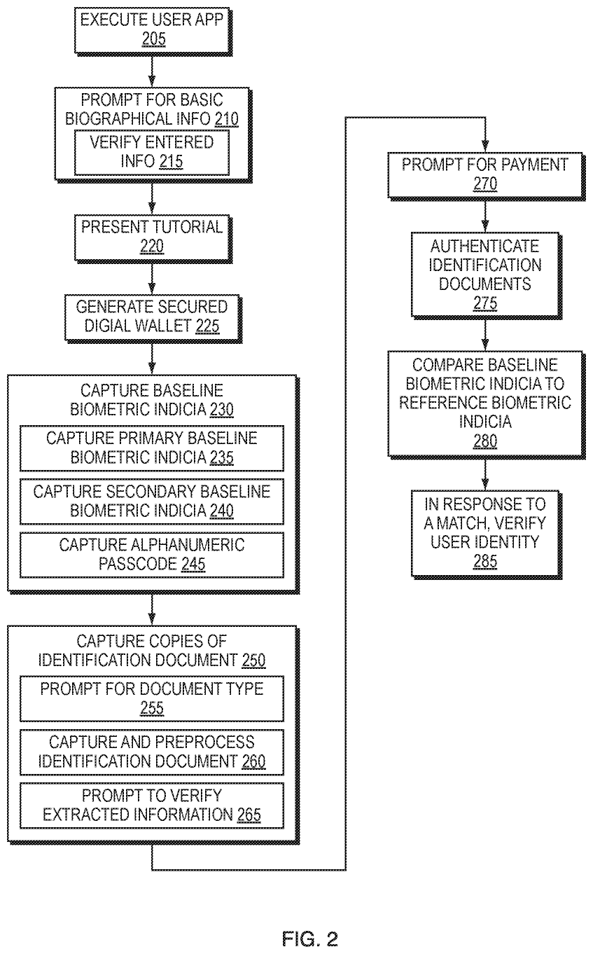

FIG. 2 is a flow diagram for an example sequence of steps for onboarding a user using the example architecture of FIG. 1. At step 205, the user executes the user app 120 on a user electronic device, and selects a “sign-up” option in the UI of the user app. At step 210, the user app 120 prompts the user for basic biographical information (e.g., email address, country, etc.). At sub-step 215, the user is prompted to verify at least some of the entered basic biographical information. For example, an email address may be verified by entry of a code sent to such address. At step 220, the user app 120 may present a tutorial (e.g., text instructions, a video, etc.) explaining the rest of the onboarding process. At step 225, the blockchain runtime generates a secured digital wallet for the user, and a unique digital identity identifier (e.g., a KYC Safe ID) that is associated therewith.

At step 230, the user app 120 captures baseline biometric indicia for the user and uploads the baseline biometric indicia via the user API 175 and blockchain API to be stored in a secured digital wallet. At sub-step 235, the user app 120 captures primary baseline biometric indicia (e.g., for the user's face). For example, the user app 120 may utilize the camera of the user electronic device to capture an image of the user's face that is distilled to a more concise form using machine learning and image processing techniques. As part of the image capture, the user app 120 may prompt the user to make certain facial expressions (e.g., smile, wink, etc.) At sub-step 240, the user app 120 captures secondary baseline biometric indicia (e.g., indicia of the user's voice). For example, the user app 120 may utilize the microphone of the user electronic device to record the user's voice, which may be distilled to more concise indicia. As part of the sound recording, the user app 120 may prompt the user to say certain phrases. At sub-step 245, the user app 120 may capture an alphanumeric passcode chosen by the user.

At step 250, the user app 120 captures copies of identification documents and uploads the copies of the identification documents via the blockchain API to be stored in the user's secured digital wallet, the document being maintained in the blockchain 194 associated with a unique digital identifier (e.g., an Asset Safe ID). For each identification document, the user app may proceed through a capture and upload flow. At sub step 255, the user app 120 may prompt the user to select an identification document type. There may be different flows depending on the selected type. At sub-step 260, the user app 120 utilizes sensors of the user electronic device to capture and pre-process the identification document. For example, the user app 120 may utilize the camera of the user electronic device to capture an image of the identification document and apply pre-processing algorithms, such as edge detection, perspective transformation, etc. The pre-processed document may then be uploaded and further processed by the document verification service 160, which uses a text reading service to extract further biographical information and reference biometric information (e.g., an image of the user's face). At sub-step 265, the user app 120 prompts the user to verify the further biographical information extracted from the identification document, to ensure it is accurate.

Depending on the onboarding process, the number and type of identification documents captured and uploaded may vary. In some cases, several levels of KYC verification, anti-fraud prevention and/or other services may be offered (e.g., gold, silver, and bronze levels) and a different numbers and types of identification documents may be required for each.

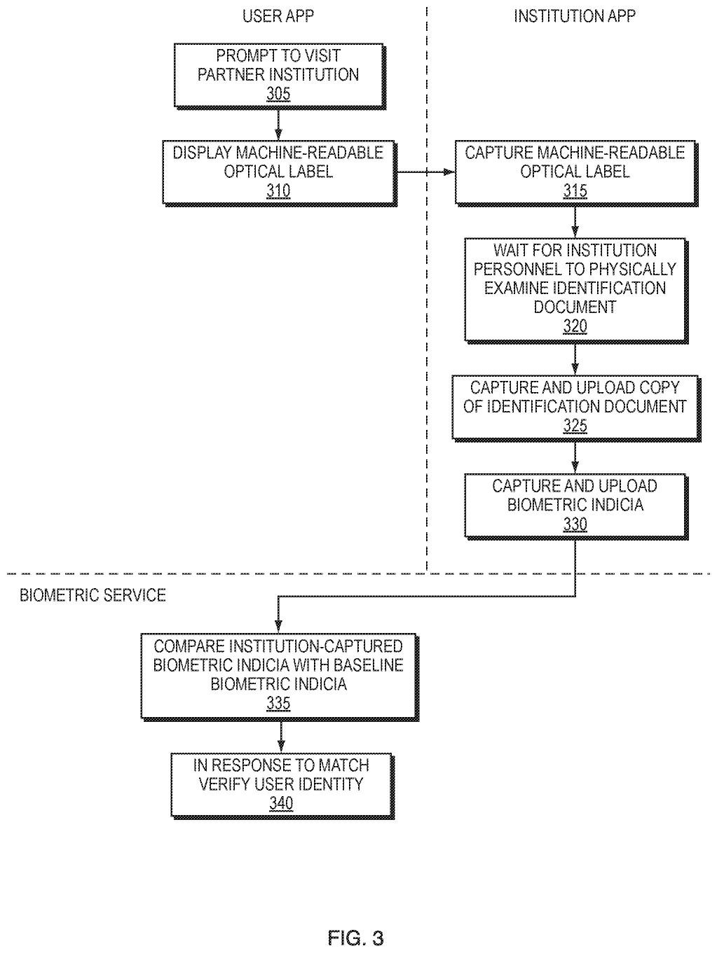

At step 270, the user app 120 prompts the user for payment to utilize the biometric identity verification and protection software solution. At step 275, the uploaded identification documents are authenticated. The steps involved in authentication may differ depending on whether the identification document at issue is machine-readable or non-machine readable. If the identification document is machine readable, the document verification service 160 may compare information in the identification document with a reference database provided by an issuer of the respective identification document, for example, provided by a government agency. If the identification document is non-machine readable, the user app 120 may notify the user that a physical verification process is required, which is further detailed below in reference to FIG. 3. Each authenticated document may be associated with a unique digital identifier (e.g., an Asset Safe ID).

At step 280, the biometric service 150 compares at least some of the baseline biometric indicia captured by the user app 120 to reference biometric indicia from an authenticated identification document. For example, the biometric service may compare the indicia of the user's face captured by the user app 120 to indicia of the user's face from an identification document, to ensure the faces match. At step 285, in response to a match between the baseline biometric indicia and the reference biometric indicia, the biometric service verifies the user's identity and provides the user with use of the secured digital wallet, assigning them a unique KYC safe ID.

FIG. 3 is a flow diagram for an example sequence of steps for authenticating a non-machine readable identification document using physical verification, which may be performed as part of step 270 of FIG. 2. At step 305, the user app 120 prompts the user to visit a partner institution, which has been authorized to authenticate identification documents. At step 310, the user app 120 displays in its UI a machine-readable optical label (e.g., a QR code) representing the user. At step 315, the intuition app 130 (being used by partner institution personnel) captures (e.g., with a camera of the institution electronic device) the machine-readable optical label (e.g., QR code). At step 320, the intuition app 130 waits while partner institution personnel physically examine the user's identification document and ensures that it is authentic and matches the user that is before them. If steps 325 and 330 are reached it is implied that the user's identification document passed physical examination.

At step 325, the intuition app 130 (being used by the partner institution personnel) captures (e.g., using a sensor, such as a camera of the institution electronic device) a copy of the non-machine readable identification document and uploads it, via the institution API 185 and blockchain API, to be stored as a verification block in the user's secured digital wallet, maintained in the blockchain 194. The document may be associated with a unique asset safe ID.

At step 330, the intuition app 130 (being used by partner institution personnel) captures (e.g., using a sensor, such as a camera of the institution electronic device) biometric indicia for the user and uploads the institution-captured biometric indicia.

At step 335, the biometric service 150 compares the institution-captured biometric indicia to baseline biometric indicia captured using the user app 120 and the copy of the non-machine readable identification document captured via the intuition app 130 to a copy of the document previously captured via the user app 120, to ensure a match. At step 340, in response to a match, the user is verified based on the non-machine readable identification document.

Once onboarding is complete, the user may utilize the user app 120 to perform a number of actions, including logging into an account at an institution, verifying incoming or outgoing transactions at the institution, etc. Further, institution personnel may use the institution app 130 to perform a variety of actions.

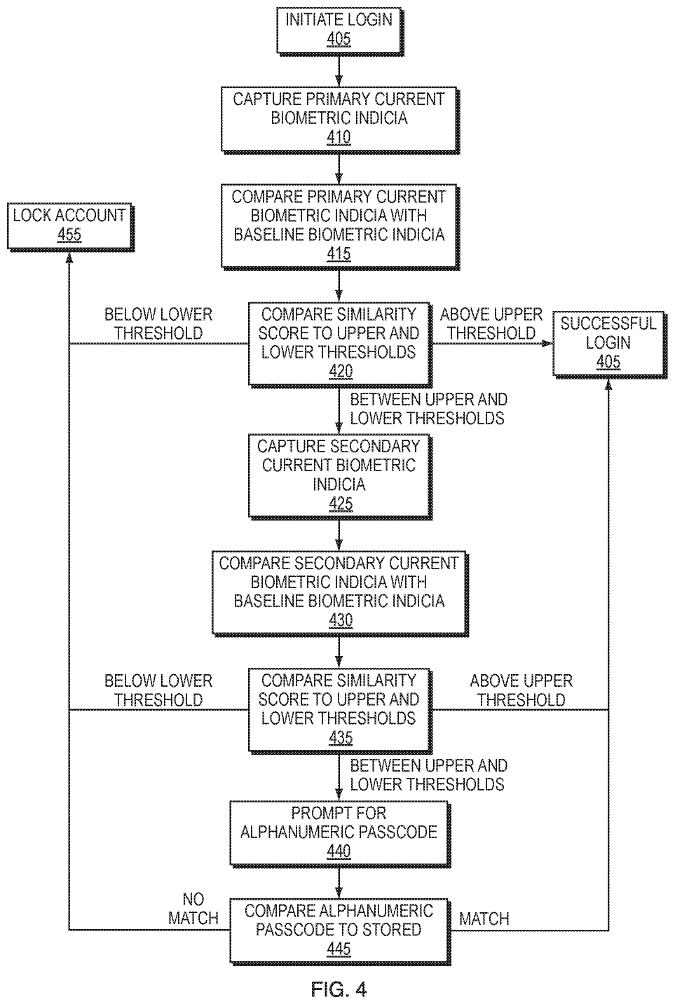

FIG. 4 is a flow diagram of an example sequence of steps for account login using the example architecture of FIG. 1. Such account login may be part of login to a financial account, an e-commerce account, a social media account, etc. at an institution that has been configured to utilize the identity verification and protection software solution. At step 405, the user initiates login using an institution app or webpage in a browser on the user electronic device. The login may trigger execution of the user app 120 on the user electronic device. The user may be required to enter a user name (e.g., their email address) in the user app 120 at this stage, or such information may be pre-filled. At step 410, the user app 120 captures primary current biometric indicia for the user, and uploads the primary current biometric indicia via the user API 175 to the biometric service 150. For example, the user app 120 may utilize the camera of the user electronic device to capture an image of the user's face. In some cases, the user app 120 may prompt the user to make certain facial expressions (e.g., smile, wink, etc.). The captured image may be distilled to a more concise form, using machine learning and image processing techniques. This more concise form may then be uploaded as the primary current biometric indicia.

At step 415, the biometric service 150 compares the primary current biometric indicia to a respective baseline biometric indicia in the user's secured digital wallet accessed from the blockchain 194, via the blockchain API. For example, the biometric service 150 may compare the indicia of the user's face captured by the user app 120 to indicia of the user's face in the secured digital wallet, to ensure the faces match. A match of the primary biometric indicia may be measured by a similarity score, which quantifies how similar the indicia are.

At step 420, the biometric service 150 compares this similarity score to upper and lower thresholds (e.g., 90% and 75% match thresholds). If the similarity score meets the upper threshold (e.g., 90%), the biometric service 150 provides an indication to the institution (e.g., to software executing on an institution server) that the user is verified, to enable a successful login, at step 450. A similarity score that meets the upper threshold indicates a high probability that the user is who they claim to be. If the similarity score does not meet the upper threshold (e.g., 90%), but meets a lower threshold (e.g., 75%), execution proceeds step 425, to check secondary current biometric indicia. A similarity score in this range indicates that the user is likely who they claim to be, but further verification is required to achieve the requisite level of certainty. External factors, such as insufficient lighting, excessive background movement, noise, etc. may cause a similarity score in this range. If the similarity score does not meet the lower threshold (e.g., 75%), an indication is provided to the institution that the user's account should be locked, at step 455. Such lock may be for a set period of time, or until a certain action is taken, for example, until physical verification is performed. A similarity score below the lower threshold indicates that the user is highly unlikely to be who they claim to be, even considering possible external factors, and a fraud event is possibly occurring.

At step 425, the user app 120 captures secondary current biometric indicia for the user, and uploads the secondary current biometric indicia, via the user API 175, to the biometric service 150. For example, the user app 120 may utilize the microphone of the user electronic device to record the user's voice. In some cases, the user app 120 may prompt the user to say a particular phrase.

At step 430, the biometric service 150 compares the secondary current biometric indicia to a respective baseline biometric indicia in the user's secured digital wallet, accessed from the blockchain 194 via the blockchain API. For example, the biometric service 150 may compare the indicia of the voice captured by the user app 120 to indicia of the user's voice in the secured digital wallet, to ensure the voices match. A match of the secondary biometric indicia may be measured by a further similarity score, which quantifies how similar the indicia are.

At step 435, the biometric service 150 compares this further similarity score to upper and lower thresholds (e.g., 90% and 75% thresholds). If the further similarity score meets the upper threshold (e.g., 90%), the biometric service 150 provides an indication to the institution (e.g., to software executing on an institution server) that the user is verified, to enable a successful login, at step 450. If the further similarity score does not meet the upper threshold (e.g., 90%), but meets the lower threshold (e.g., 75%), execution proceeds to step 440, to check an alphanumeric passcode. If the further similarity score does not meet the lower threshold (e.g., 75%), an indication is provided to the institution (e.g., to software executing on an institution server) that the user's account should be temporarily locked, at step 455.

At step 440, the user app 120 prompts the user to enter an alphanumeric passcode. At step 445, the alphanumeric passcode is compared to the alphanumeric passcode in the user's secured digital wallet. If there is a match, the biometric service 150 provides an indication to the institution (e.g., to software executing on an institution server) that the user is verified, to enable a successful login, at step 450. If not, an indication is provided to the institution (e.g., to software executing on an institution server) that the user's account should be temporarily locked, at step 455.

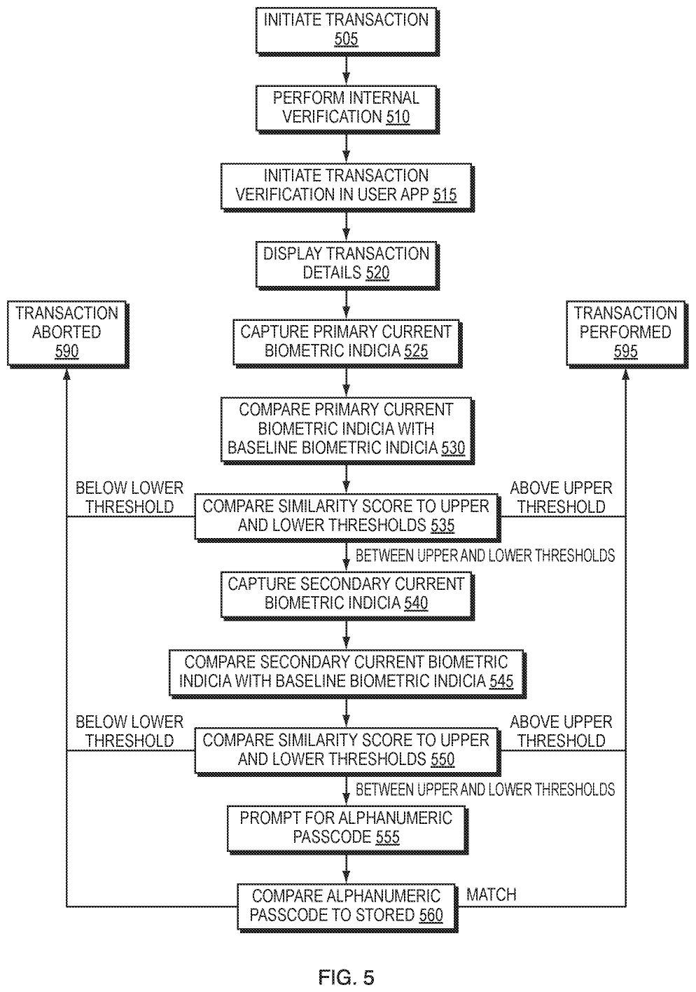

FIG. 5 is a flow diagram of an example sequence of steps for transaction verification using the example architecture of FIG. 1. Such transaction verification may be for incoming or outgoing transactions (e.g., financial, e-commerce, etc.) to prevent fraud. At step 505, the user initiates a transaction using an app or webpage in a browser on the user electronic device. At a subsequent time, at step 510, the institution (e.g., using software executing on an institution server) performs internal verification procedures. If the internal verification procedures are not passed, the transaction is aborted at step 590. As part of step 590, a transaction failure notification may be displayed in the app or webpage in the browser on the user electronic device.

If the internal verification procedures are passed, the institution sends a transaction verification request to the institution API 185, including details of the transaction (e.g., name, amount, etc.), and execution proceeds to step 515. At step 515, a transaction verification is initiated, and the user API 175 pushes a message to the user app 120 including the details of the transaction. At step 520, the user app 120 displays in its UI a notification with the details of the transaction. At step 525, the user app 120 captures primary current biometric indicia for the user and uploads the primary current biometric indicia via the user API 175 to the biometric service 150. For example, the user app 120 may utilize the camera of the user electronic device to capture an image of the user's face. In some cases, the user app 120 may prompt the user to make certain facial expressions (e.g., smile, wink, etc.).

At step 530, the biometric service 150 compares the primary current biometric indicia to a respective baseline biometric indicia in the user's secured digital wallet, accessed from the blockchain 194 via the blockchain API. For example, the biometric service 150 may compare the indicia of the user's face captured by the user app 120 to indicia of the user's face in the secured digital wallet, to ensure the faces match. A match of the primary biometric indicia may be measured by a similarity score (as discussed above), which quantifies how similar the indicia are.

At step 535, the biometric service 150 compares this similarity score to upper and lower thresholds (e.g., 90% and 75% match thresholds). If the similarity score meets the upper threshold (e.g., 90%) the biometric service 150 provides an indication to the institution (e.g., to software executing on an institution server) that the user is verified, and execution proceeds to step 595, where the transaction is performed by the institution. As part of step 595, a transaction success notification may be displayed in the app or webpage in the browser on the user electronic device. If the similarity score does not meet the upper threshold (e.g., 90%), but meets a lower threshold (e.g., 75%), execution proceeds step 540 to check secondary current biometric indicia. If the similarity score does not meet the lower threshold (e.g., 75%), an indication is provided to the institution (e.g., to software executing on an institution server) that the transaction should be aborted due to failed user verification. Execution proceeds to step 590, where the transaction is aborted, and a transaction failure notification potentially displayed in the app or webpage in the browser on the user electronic device.

At step 540, the user app 120 captures secondary current biometric indicia for the user, and uploads the secondary current biometric indicia via the user API 175 to the biometric service 150. For example, the user app 120 may utilize the microphone of the user electronic device to record the user's voice. In some cases, the user app 120 may prompt the user to say a particular phrase.

At step 545, the biometric service 150 compares the secondary current biometric indicia to a respective baseline biometric indicia in the user's secured digital wallet, accessed from the blockchain 194 via the blockchain API. For example, the biometric service 150 may compare the indicia of the voice captured by the user app 120 to indicia of the user's voice in the secured digital wallet, to ensure the voices match. A match of the secondary biometric indicia may be measured by a further similarity score that quantifies how similar the indicia are.

At step 550, the biometric service 150 compares this further similarity score to upper and lower thresholds (e.g., 90% and 75% match thresholds). If the further similarity score meets the upper threshold (e.g., 90%), the biometric service 150 provides an indication to the institution (e.g., to software executing on an institution server) that the user is verified, and execution proceeds to step 595, where the transaction is performed by the institution. As part of step 595, a transaction success notification may be displayed in the app or webpage in the browser on the user electronic device. If the further similarity score does not meet the upper threshold (e.g., 90%), but meets a lower threshold (e.g., 75%), execution proceeds step 555, to check an alphanumeric passcode. If the further similarity score does not meet the lower threshold (e.g., 75%), an indication is provided to the institution (e.g., to software executing on an institution server) that the transaction should be aborted due to failed user verification. Execution proceeds to step 590, where the transaction is aborted, and a transaction failure notification potentially displayed in the app or webpage in the browser on the user electronic device.

At step 555, the user app 120 prompts the user to enter an alphanumeric passcode. At step 560, the alphanumeric passcode is compared to the alphanumeric passcode in the user's secured digital wallet. If there is a match, the biometric service 150 provides an indication to the institution (e.g., to software executing on an institution server) that the user is verified, and execution proceeds to step 595, where the transaction is performed by the institution. As part of step 595, a transaction success notification may be displayed in the app or webpage in the browser on the user electronic device. If not, an indication is provided to the institution (e.g., to software executing on an institution server) that the transaction should be aborted due to failed user verification. Execution proceeds to step 590, where the transaction is aborted, and a transaction failure notification potentially displayed in the app or webpage in the browser on the user electronic device.

The transaction verification of the biometric identity verification and protection software solution may be adapted to enable real-time anti-money laundering compliance. Each incoming and outgoing transaction may require identity verification, across multiple institutions. Institutions may define a transaction limit for each identity. Once the transaction limit is reached, the user app 120 may present a prompt that supporting documentation is required. The user may then utilize the user app 120 to capture copies of supporting documents and upload the copies of supporting documents via the user API 175 and blockchain, to be stored as a verification block in their secured digital wallet in the blockchain 194. The document verification service 160 compares information in the supporting document (e.g., name, date of contract, counter party, etc.) with details of the transaction, and shares results with the institution (e.g., with software executing on an institution server). The institution may permit the transaction, prevent the transaction, or perform further anti-money laundering compliance checks to reach a determination.

Further, the biometric identity verification and protection software solution may also be adapted to provide unknown person identification services (e.g., for use with border control, human trafficking, child trafficking and other type of customs, border and law enforcement activities. The unknown person identification services may span traditional geo-political borders, utilizing information for users of the biometric identity verification and protection software solution in multiple countries. To facilitate searching, baseline biometric indicia in the secured digital wallets of the system may be converted into feature tokens maintained in a database. A feature token of an unknown person may then be compared against the feature token database.

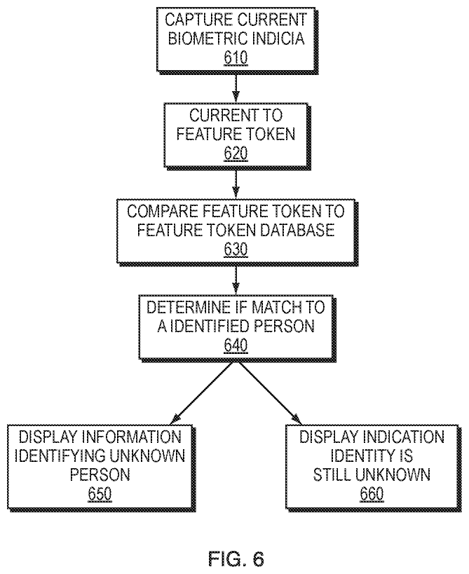

FIG. 6 is a flow diagram of an example sequence of steps for unknown person identification. At step 610, an institution app 130 executing on an institution electronic device is used by institution personal to capture current biometric indicia for an unknown person, and upload the current biometric indicia via the institution API 185. For example, the institution app 130 may utilize the camera of the institution electronic device to capture an image of the unknown person's face. At step 620, the biometric service 150 converts the current biometric indicia into a feature token that represents the biometric information in a more concise form. At step 630, the biometric service 150 compares the feature token to feature tokens of a feature token database for a plurality of users (e.g., all users, or subset of users defined based on one or more criteria, such as age, gender, geographic location, etc.). A similarity score for each is generated based on the comparison. At step 640, the biometric service 150 determines if there is a match to any of the users. A match may be declared if the comparison yields a similarity score that meets a predetermined threshold (e.g., 90%). If there is a match, at step 650, the institution app 130 displays information identifying the unknown user. If there is not a match, at step 660, the institution app 130 displays an indication the person's identity is still unknown. In some cases, notifications may also be sent to other user apps, for example, to the user app 120 of a parent (e.g., in a child trafficking application), or to institution apps 130 of other institutions.

It should be understood that a wide variety of additional adaptations and modifications may be made to the above described biometric identity verification and protection software solution. Such adaptions and modifications may tailor the solution to specific use cases or enhance the functionality of the solution in all use cases.

For example, liveness and coercion detection may be integrated to enhance functionality. In one embodiment, “biometric pin” verification may be employed, which combines biometric and passcode verification into a single step. One vulnerability of biometric verification systems is that they can potentially be tricked by recorded biometrics (e.g., a photograph of the user's face, a sound recording of their voice, etc.) or by a user who is being coerced (e.g., by a criminal forcing them to present their face, voice, etc.). Liveness and coercion detection seek to address this issue.

In one implementation, a “biometric pin” is used which takes the form of a numbered combination of multiple (e.g., 4) gestures that the user is required to both identify and recreate. For example, for a “biometric pin” that involves the user's face, the user may select a set (e.g., 4) facial gestures (e.g., smile, blink, wink right eye and wink left eye) from a larger collection of possibilities (e.g., blink, smile, wink with left eye, wink with right eye, tilt face right, tilt face left, look right, look left, etc.). As part of account login or transaction verification, the user app 120 shows the user a collection of possible facial gestures, including the selected set and several decoy options, with each facial gesture associated with a random identifier (e.g., a randomly assigned number). The user app 120 prompts the user to indicate (e.g., voice) the random identifier of the facial gestures in their biometric pin, which fulfils the identification requirement, and then produce the facial gestures which fulfills the recreation requirement. Anti-coercion protection may be provided via an “emergency biometric pin.” The “emergency biometric pin” may be entered similarly to the regular “biometric pin”, and may seemingly provide access to an account or verify a transaction, but may trigger a hidden alert to law enforcement, a hidden freeze on the transaction, or other covert law enforcement or anti-fraud response.

In another implementation, the “biometric pin” may take the form of a random biometric input that the user is required to produce. For example, for a “biometric pin” that involves the user's voice, the user app 120 may show a randomly generated set of items (characters, words, etc.) that the user is required to voice aloud. The user's face and voice may be captured and analyzed by the biometric service 160 to ensure a live human has recreated the set of items.

It should be understood that a wide variety of additional adaptations and modifications may be made to the above described biometric identity verification and protection software solution. In general, functionality may be implemented in software, hardware or various combinations thereof. Software implementations may include electronic device-executable instructions (e.g., computer-executable instructions) stored in a non-transitory electronic device-readable medium (e.g., a non-transitory computer-readable medium), such as a volatile memory, a persistent storage device, or other tangible medium. Hardware implementations may include logic circuits, application specific integrated circuits, and/or other types of hardware components. Further, combined software/hardware implementations may include both electronic device-executable instructions stored in a non-transitory electronic device-readable medium, as well as one or more hardware components. Above all, it should be understood that the above description is meant to be taken only by way of example.

What is claimed is:

1. A method for biometric identity verification and protection, comprising:
onboarding a user by at least:
capturing, by a user application (app) executing on an electronic device, baseline biometric indicia for the user and uploading the baseline biometric indicia to a cloud-based service,
capturing a copy of one or more identification documents and uploading the copy of the one or more identification documents to the cloud-based service,
authenticating the one or more identification documents,
comparing, by the cloud-based service, the baseline biometric indicia to reference biometric indicia in at least one of the authenticated identification documents, and
in response to a match between the baseline biometric indicia and the reference biometric indicia, verifying, by the cloud-based service, the user's identity and providing use of a secured digital wallet, wherein the secured digital wallet maintains the baseline biometric indicia and the copy of the one or more identification documents; and
verifying a given action as being performed by the user, by at least:
capturing, by the user app executing on the electronic device, current biometric indicia for the user and uploading the current biometric indicia to the cloud-based service,
comparing, by the cloud-based service, the current biometric indicia to baseline biometric indicia in the secured digital wallet, and
in response to a match between the current biometric indicia and the baseline biometric indicia, providing an indication to an institution that the user is verified.

2. The method of claim 1, wherein the identification documents include at least one non-machine readable identification document, and the onboarding further comprises:
capturing, by an institution app executing on another electronic device, an institution-captured copy of the non-machine readable identification document when the user has physically presented themselves at a partner institution for verification;
uploading, by the institution app, institution-captured biometric indicia for the user; and
comparing, by the cloud-based service, the institution-captured biometric indicia to the baseline biometric indicia,
wherein verification is further in response to a match between the institution-captured biometric indicia and the baseline biometric indicia.

3. The method of claim 1, wherein the identification documents include a machine readable identification document, and the authenticating further comprises:
digitally comparing, by the cloud-based service, information in the machine readable identification document with information in a reference database of an issuer of the machine readable identification document.

4. The method of claim 1, wherein the baseline biometric indicia includes primary baseline biometric indicia and secondary baseline biometric indicia.

5. The method of claim 4, wherein the primary baseline biometric indicia include an indicia of the user's face, and the secondary baseline biometric indicia include an indicia of the user's voice.

6. The method of claim 4, wherein the comparing the current biometric indicia to the respective baseline biometric indicia further comprises:
comparing the primary current biometric indicia with the primary baseline biometric indicia and generating a first similarity score;
in response to the first similarity score meeting a first upper threshold, declaring the match between current biometric indicia and baseline biometric indicia;
in response to the first similarity score not meeting the first upper threshold, but meeting a first lower threshold, also comparing the secondary current biometric indicia with the secondary baseline biometric indicia and generating a second similarity score; and
in response to the second similarity score not meet a second lower threshold, temporarily locking the user's account.

7. The method of claim 6, wherein the comparing the current biometric indicia to the respective baseline biometric indicia further comprises:
in response to the second similarity score meeting a second upper threshold, declaring the match between the current biometric indicia and the baseline biometric indicia; and
in response to the second similarity score meeting not meeting the second upper threshold, but meeting the second lower threshold, defaulting to verification of an alphanumeric passcode.

8. The method of claim 1, wherein the given action is an account login, and the indication to the institution indicates the user is verified to login to the account.

9. The method of claim 1, wherein the given action is a transaction verification, the verifying the given action is in response to receipt of a verification request, and the indication to the institution is a response to the verification request.

10. The method of claim 9, wherein the transaction verification is in response to a real-time anti-money laundering compliance program.

11. A method for biometric unknown person identification, comprising:
identifying a person by at least:
capturing, by a first application (app) executing on an electronic device, baseline biometric indicia for a person and uploading the baseline biometric indicia to a cloud-based service,
capturing, by the first app, a copy of one or more identification documents and uploading the copy of the one or more identification documents to the cloud-based service,
authenticating the one or more identification documents,
comparing the baseline biometric indicia to reference biometric indicia in at least one of the authenticated identification documents,
in response to a match between the baseline biometric indicia and the reference biometric indicia, verifying the person's identity, and
generating a feature token for the identified person based on the baseline biometric indicia and storing the feature token for the identified person in a feature token database; and
identifying an unknown person by:
capturing, by a second app executing on another electronic device, current biometric indicia for the unknown person and uploading the current biometric indicia for the unknown person to the cloud-based service,
converting the current biometric indicia for the unknown person into a feature token for the unknown person,
comparing the feature token for the unknown person to feature tokens in the feature token database, and
in response to a match to the feature token for the identified person, providing information identifying the identified person.

12. The method of claim 11, wherein the providing information identifying the unknown person further comprises:
providing information regarding one or more identification documents from a secured digital wallet of the identified person.

13. The method of claim 11, wherein the identification documents include a non-machine readable identification document, and the identifying the person comprises:
capturing an institution-captured copy of the non-machine readable identification document when the person has physically presented themselves at a partner institution for verification;
uploading institution-captured biometric indicia for the person;
comparing institution-captured biometric indicia to the baseline biometric indicia,
wherein verification is further in response to a match between the institution-captured biometric indicia and the baseline biometric indicia.

14. The method of claim 11, wherein the identification documents include a machine readable identification document, and the identifying the person further comprises:
digitally authenticating information in the machine readable identification document with an issuer of the machine readable identification document.

15. The method of claim 11, wherein the baseline biometric indicia include primary baseline biometric indicia and secondary baseline biometric indicia.

16. The method of claim 15, wherein the primary baseline biometric indicia include an indicia of the person's face, and the secondary baseline biometric indicia include an indicia of the person's voice.

17. A non-transitory electronic device readable medium having instructions stored thereon that when executed on one or more electronic devices are operable to:
capture baseline biometric indicia;
capture one or more identification documents;
authenticate the one or more identification documents;
compare the baseline biometric indicia to reference biometric indicia in at least one of the authenticated identification documents;
in response to a match between the baseline biometric indicia and the reference biometric indicia, verify the user's identity;
capture current biometric indicia for the user;
compare the current biometric indicia to baseline biometric indicia; and
in response to a match between the current biometric indicia and the baseline biometric indicia, provide an indication that the user is verified.

18. The non-transitory electronic device readable medium 17, wherein the identification documents include at least one non-machine readable identification document, and the instructions when executed are further operable to:
capture an institution-captured copy of the non-machine readable identification document when the user has physically presented themselves at a partner institution for verification;
upload institution-captured biometric indicia for the user; and
compare the institution-captured biometric indicia to the baseline biometric indicia,
wherein verification is further in response to a match between the institution-captured biometric indicia and the baseline biometric indicia.

19. The non-transitory electronic device readable medium 17, wherein the identification documents include a machine readable identification document, and the instructions when executed are further operable to:
digitally compare information in the machine readable identification document with information in a reference database of an issuer of the machine readable identification document.

20. The non-transitory electronic device readable medium 17, wherein the baseline biometric indicia includes primary baseline biometric indicia and secondary baseline biometric indicia, and the primary baseline biometric indicia include an indicia of the user's face, and the secondary baseline biometric indicia include an indicia of the user's voice.
